(19) United States
(12) Patent Application Publication
(10) Pub. No.: US 2026/0038858 A1
(43) Pub. Date: Feb. 5, 2026

(54) FUEL CELL SYSTEM WITH SEPARATION OF HYDROGEN GAS FROM ANODE EXHAUST GAS AND METHOD OF ITS OPERATION AS WELL AS USE THEREOF

(71) Applicant: BLUE WORLD TECHNOLOGIES HOLDING APS, Aalborg Oest (DK)

(72) Inventor: Mads BANG, Støvring (DK)

(73) Assignee: BLUE WORLD TECHNOLOGIES HOLDING APS, Aalborg Oest (DK)

(21) Appl. No.: 19/138,982

(22) PCT Filed: Dec. 15, 2023
(86) PCT No.: PCT/DK2023/050316

§ 371 Date: Jun. 13, 2025

(30) Foreign Application Priority Data
Dec. 19, 2022 (DK) PA202201173

(51) Int. Cl. H01M 8/0662; H01M 8/0612; H01M 8/0668; H01M 8/12

(52) U.S. Cl. CPC H01M 8/0681; H01M 8/0618; H01M 8/0668; H01M 8/12; H01M 2250/20

(57) ABSTRACT

In a fuel cell system with a HT-PEM fuel cell, hydrogen is separated from the anode exhaust gas and recycled into the anode to increase efficiency. Instead of burning the hydrogen in a reformer-heater, the reformer is heated electrically or by using a heat pump. Separation of H2 from the anode exhaust gas leaves an option for collecting the remaining CO2 after condensing the water from the anode exhaust gas.

### FIELD OF THE INVENTION

The present invention relates to a fuel cell system comprising a hydrogen separator for separating hydrogen gas, H2, from the anode exhaust gas and recirculation of the separated H2 gas back into the anode. In particular, it relates to a system as described in the preamble of the independent claim and its use as well as a method of its operation.

### BACKGROUND OF THE INVENTION

For feeding fuel cells with hydrogen gas, H2, or hydrocarbons, various options exist, including pressurised H2, methane, or alcohols, for example methanol or ethanol. Typical gas fuels for fuel cells include ethane, propane, and natural gas. Alcohol fuel for fuel cells is advantageous in that existing liquid fuel infrastructure for diesel and gasoline to a large extent can be re-used, which includes also transport of the fuel to supply stations and storage of the fuel in a vehicle.

When using methane or alcohols as fuel, it has to be converted into H2 gas. The corresponding reformation reaction in a catalytic reformer is endothermic and requires energy. For supplying such energy by heating the reformer, a reformer-heater is provided in the fuel cell system. Typically, the reformer-heater is a burner that burns fuel for providing thermal energy. The term burner is common in the technical field, irrespective of the burner using a traditional flame or a catalytic consumption of the fuel for producing the necessary thermal energy. As an option, the burner consumes excess H2 gas from the anode exhaust gas of the fuel cell. When using methanol, the temperature for reformation is typically 250° C. The reformer heater adds thermal energy at a rate sufficient for maintaining the reformation process, in particular 49 kJ/mol for the reaction of methanol and water being reformed into CO2 and H2.

The reformation of the fuel produces syngas, which is a mix of gases, including H2 gas, carbon dioxide, CO2, carbon monoxide, CO, and some remains of water, H2O. For fuel cells with Polymer Electrolyte Membranes (PEM) at low temperature, which is below 100° C., which is why this type of fuel cells is called LT-PEM fuel cells or just PEM fuel cells, the catalysts are sensitive to CO gas at these temperatures so that this is converted into CO2 in a shift reactor prior to the syngas entering the fuel cell. For typical High-Temperature PEM fuel cells, HT-PEM fuel cells, operating at higher temperatures, above 120° C. and even up to 200° C., the system is more robust against CO gas, and a shift reactor can be avoided as well as other clean-up processes for the gas.

As fuel cells are becoming increasingly attractive for production of electrical power, in particular in vehicles, such as electrically driven automobiles and marine vessels, there is a steady urge to increase the efficiency for power production, where even improvement in the order of a single percentage is attractive. Accordingly, there is a demand for improvements in the technical field.

For example, in US patent publication US2010/0266923A1, an electrochemical hydrogen separator is disclosed for separating H2 gas from a fuel cell anode exhaust gas and re-introduce this into the fuel cell in order to optimize efficiency of the fuel cell. Monitoring of the performance of the hydrogen separation device gives an indication as to the fuel cell system performance. When H2 gas is separated from the anode exhaust gas stream and recycled into the fuel cell anode, it disappears as fuel for the reformer-heater. This is not a problem for SOFC cells working temperatures in the range of 750° C.-950° C., as disclosed in US2010/0266923A1, because the excess heat of the fuel cell can be used for heating not only the electrochemical H2-separator, as illustrated in this disclosure, but also the reformer.

However, for fuel cells operating at lower temperature, fuel is traditionally used for heating the reformer, so that H2-separation and reintroduction into the anode does not bring about any apparent efficiency advantage.

This consideration is supported by study of the system disclosed in the German patent application DE102013009244A1, in which a membrane-separator is used for separating H2 from the anode gas in order to capture the remaining CO2 in a storage tank after removal of water by condensation. In this reference, membranes are used for transport of H2 out of a gas stream and into an H20 stream for H2-enriching the fuel gas stream for the reformer-heater. This follows the traditional approach of using H2 in the cycle for introduction into a reformer-burner, be it by flame or by catalytic burning, for heating the reformer. As an additional option, DE102013009244A1 discloses H2-enrichment of the methane gas stream that goes into the catalytic reformer. However, in a closer evaluation, this does not appear optimum, as the elevated H2 levels in the gas stream at the inlet of the reformer can be expected to not increase but instead reduce the overall efficiency of the reformation, seeing that the H2 concentration is already offset to a substantial concentration level from the onset in the reformer, so that the additional H2-production capabilities in the reformer up to a maximum concentration of H2 in the gas is not optimised. Accordingly, it is understood from the disclosure in DE102013009244A1 that the separation of H2 from the anode gas exhaust is not motivated by a general objective of increasing the efficiency of the fuel cell system, but the separation is motivated by finding some meaningful use of the separated of H2 gas from the anode exhaust, which is rather a by-product, prior to capturing carbon from the exhaust stream, the carbon capture being the main objective of DE102013009244A1.

In the article, “Electrochemical hydrogen pumping using a high-temperature polybenzimidazole (PBI) membrane” published by Perry et al. in Journal of Power Sources 177 (2008) 478-484, electrochemical hydrogen separation from a mix of gases, including N2, H2, CO, and CO2, was disclosed using a high-temperature (>100° C.) polybenzimidazole (PBI) membrane. In particular, the electrochemical pump was operated at 160° C. on approximately 1.2 times that of the stoichiometric requirements of pure hydrogen without external humidification. It is pointed out that such hydrogen pump is operated at a temperature similar to the coolant temperature of HT-PEM fuel cell, whereas the coolant from a LT-PEM fuel cell, such as disclosed in the above-mentioned DE102013009244A would not deliver a sufficiently high temperature.

For fuel cell systems in which the fuel cell operates at temperatures below the temperature necessary for reformation of the fuel, separation of H2 from the anode exhaust gas and recycling thereof into the fuel cell would be useful, however, if, on the one hand, a method can be found for heating the reformer differently from a burner and, on the other hand, the efficiency would be higher in such a setup than in a comparable system where the H2 is burned in a reformer heater.

### DESCRIPTION/SUMMARY OF THE INVENTION

It is an objective of the invention to provide an improvement in the art. In particular, it is an objective to provide a higher efficiency of a HT-PEM fuel cell system that comprises a reformer. This objective and further advantages are achieved with a fuel cell system and a method of its operation as described below and in the claims.

In short, in a fuel cell system with a HT-PEM fuel cells, hydrogen is separated from the anode exhaust gas and recycled into the anode in order to increase efficiency. Instead of burning hydrogen or fuel in a reformer-heater, the reformer is heated by an electrical driven reformer-heater, for example an electrical heater or an electrically driven heat pump system. Separation of H2 gas from the anode exhaust gas leaves an option for collecting the remaining CO2 after condensing the water.

Details are explained in the following.

An HT-PEM fuel cell is provided, typically as part of a stack of fuel cells, which is common practice. The fuel cell has a membrane and an anode side on one side of the membrane and a cathode side on the opposite side of the membrane. In the following, the short terminology of anode and cathode will be used for the fuel cell.

The fuel cell system comprises a fuel supply for providing alcohol, such as ethanol but especially methanol, after evaporation into a reformer, typically after mixing with water, so that the fuel cell can be fed with H2 gas after reformation of the fuel. The catalytic reformation of the fuel produces not only H2 but also other gas by-products, such as CO2, water, CO. As discussed above, for HT-PEM fuel cells, the removal of CO is typically not necessary.

The anode of the fuel cell has an inlet that is flow-connected to the reformate-outlet by a syngas-conduit and receives syngas from the reformer for the reaction in the fuel cell; and the cathode receives oxygen gas, for example as part of air. In HT-PEM fuel cells, hydrogen ions traverses the ion-conducting membrane from the anode side to the cathode side and form water in the cathode. The water leaves the cathode as steam together with other gaseous components, such as nitrogen from supplied air.

The anode consumes a dominant first portion of the received H2 for producing electricity, and a minor second portion is released in the exhaust gas from the anode.

The operation temperature of the HT-PEM fuel cell is in the range of 120° C.-200° C., typically in the range of 150° C.-180° C., which is less than the minimum temperature necessary for the catalytic reformation of the fuel, which for ethanol is above 400° C. and for methanol above 200° C. Typically, for methanol, the predetermined reformer temperature T_{ref} is in the range of 250° C.-300° C., which is higher.

Instead of burning H2 and/or fuel in a reformer burner, as per the prior art, the reformer reformer-heater is electrically driven. For example, the reformer heater comprises an electrical heater where electricity is used to heat heating elements by electrical current through the heating elements. Alternatively, the reformer heater comprises an electrically driven heat pump. The latter has turned out to have special advantages, as explained below.

A consequence of using an electrically driven reformer-heater is that there is no need of H2 gas and other fuel for the reformer burner, and H2 gas can be captured from the anode exhaust gas and recycled into the anode, which optimises performance of the system.

Accordingly, for the separation, a hydrogen separator is connected to a downstream side of the anode for receiving the anode exhaust gas and for separating H2 gas from the anode exhaust gas. The hydrogen separator is on its downstream side connected to a syngas conduit that extends between a downstream side of the reformer and an upstream side of the anode. This way, it is possible to feed the separated H2 from the anode exhaust gas back to the anode after mixing with syngas from the reformer.

Different types of H2-separators can be used, for example involving Pressure Swing Adsorption techniques, amine absorption, and electrochemical separation, the latter being particularly advantageous and is discussed in greater detail in the following.

In this connection, a comparison should be made with the above-mentioned reference DE102013009244A1, for which it is observed that the only example of direct recycling of H2 into the anode is illustrated in FIG. 3 of DE102013009244A1, in which, however, the anode does not receive syngas, in contrast to the system described herein. Instead, in DE102013009244A1, a recycled H2O steam with the recycled H2 receives additional H2 from the syngas across an H2-separating membrane, and the resulting H2-enriched recycled steam is used for feeding not only the anode but also the reformer-burner after a splitting of the flow into respective separate conduits. This is a different system with different function than the one described herein.

In comparison, in the HT-PEM system described herein with the electrically driven reformer-heater instead of a reformer-burner, the H2-separator is only working on the anode exhaust gas and not on the syngas from the reformer, which is in contrast to DE102013009244A1. Accordingly, the necessary capacity of the H2-separator in the system as described herein can be designed much smaller than the H2 membrane-separator in DE102013009244A1. This is another advantage over DE102013009244A1.

In contrast to an LT-PEM fuel cell, for example disclosed in the above-mentioned reference DE102013009244A1, there is no need for a high concentration of H2O steam in the gas supply to the anode of a HT-PEM fuel cell. Accordingly, the principle of DE102013009244A1 of using a recycled stream of H2 steam on one side of a H2-separation membrane for forcing transport of H2 across the H2-separation membrane does not appear useful for HT-PEM fuel cell systems, and high concentration of steam is even not desired because it may even be detrimental to the functioning of the HT-PEM fuel cells, in particular the catalysts used therein.

Instead, it has been found, that electrochemical separation of hydrogen gas is better than the membrane separation system of DE102013009244A1.

As an option for electrochemical separation of hydrogen gas, a hydrogen pump as H2-separator can be used of the type as disclosed in the article, “Electrochemical hydrogen pumping using a high-temperature polybenzimidazole (PBI) membrane” published by Perry et al. in Journal of Power Sources 177 (2008) 478-484 and references therein. As already mentioned in the introduction, this article discloses electrochemical hydrogen separation from a mix of gases, including N2, H2, CO, and CO2, was disclosed using a high-temperature (>100° C.) polybenzimidazole (PBI) membrane. In particular, the electrochemical pump was operated at 160° C. on approximately 1.2 times that of the stoichiometric requirements of pure hydrogen without external humidification. Relatively low voltages, less than 1 V, were required to operate the hydrogen pump over a wide range of hydrogen flow rates.

It is pointed out that such a hydrogen pump is operated at a temperature of 160° C., which is similar to the coolant temperature of HT-PEM fuel cell, whereas the coolant from a LT-PEM fuel cell, such as disclosed in the above-mentioned DE102013009244A, would be below 100° C. and, thus, not deliver a sufficiently high temperature.

A pronounced advantage of electrochemical H2 separation, in contrast to a passive membrane, such as in DE102013009244A, is the possibility of monitoring of the performance of the H2-separator, in particular the electricity consumption, which gives an indication of the fuel cell system performance. In some embodiments of the invention described herein, such monitoring of the performance of the fuel cell system is done. For example, the H2 production can be monitored and the fuel feed lambda value determined.

Having separated H2 from the anode exhaust gas by the H2-separator, and after removal of water, typically by condensation, the remaining gas contains almost exclusively CO2. As an option, this is liquefied and stored in tanks as a carbon capturing measure.

As mentioned above, HT-PEM fuel cells are advantageous in that they are robust against CO in the gas from the reformer so that a shift gas reactor can be avoided. As a consequence, relatively small and lightweight reformers can be used, which is an advantage due to corresponding small dimensions of the electrically driven reformer heater, for example heat pump system. Although heat pumps may be advantageous from different perspectives for various types of fuel cell systems, it appears that, in particular, HT-PEM fuel cell systems can benefit from using heat pumps or electrical heaters for the heating of the reformer.

An example is given in the following where the HT-PEM fuel cell is operated at a temperature around 170° C., which is the temperature of the coolant at the outlet of the fuel cell stack. Slight temperature variations along the fuel cell stack, however, are normal, so that the operational temperature of the fuel cell stack is typically no more precise than a predetermined temperature +/−10 degrees. For a set operational temperature of 170° C., which is the temperature by which the coolant leaves the fuel cell stack, the fuel cell stack would have temperature variations in the range of 160-180° C. In particular, the coolant that leaves the fuel cell at T2=170° C. would enter the fuel cell stack at a lower temperature T1, for example T1=160° C., which is one of the reasons for the temperature variations within the stack.

The necessary minimum temperature for the reformation of methanol is 200° C. and, typically, the predetermined temperature T_{ref} is in the range of 250° C.-300° C., and a temperature or T_{ref}=250° C. is useful.

The above objective is also achieved by a method is provided, which comprises—using electricity in an electrically driven reformer heater for heating a catalytic reformer by the reformer-heater to a predetermined reformer temperature T_{ref} not lower than a minimum temperature necessary for catalytic reformation of fuel into syngas containing hydrogen, H2; for example, the predetermined reformer temperature T_{ref}, is in the range of 250° C.-300° C. for reformation of methanol;
operating a fuel cell, for example operating an HT-PEM fuel cell at an operation temperature in the range of 120° C.-200° C., optionally in the range of 150° C.-180° C.;
maintaining the operation temperature of the fuel cell by a cooling circuit containing a flow of coolant;
reforming fuel comprising alcohol, such as methanol, by the reformer into syngas containing hydrogen, H2, and feeding the syngas into an anode of the fuel cell and producing electricity by the fuel cell by consuming a first portion of the H2, and releasing a second portion of the H2 from the anode as part of an anode exhaust gas;
receiving the anode exhaust gas by an H2-separator and separating a remaining portion of the H2 from the anode exhaust gas and recycling the separated H2 into the anode after mixing with the syngas from the reformer.

In contrast to the prior art, the reformer-heater in the system presented herein comprises an electrically driven reformer-heater. In some embodiments, the reformer-heater is an electrical heater in which electricity is converted into heat by ohmic resistance; this type of heating also called ohmic heating. For a reformation of methanol into syngas, the herein described HT-PEM fuel cell system with an electrical heater surprisingly turned out to yield an improvement of 1% efficiency when H2 is recycled as compared to a reformer-heater on fuel and/or anode exhaust gas.

Alternatively, the electrically driven reformer-heater comprises an electrically driven heat pump, which in such HT-PE fuel cell systems as described herein improves the efficiency by more than 5%, which is very surprising but reasoned in the following. A heat pump does not burn fuel or recycled heat gas. Instead, electricity is consumed, for example produced by the fuel cell. This way, the driving of the heat pump indirectly consumes H2 due to the necessary additional production of electricity by the fuel cell. However, this has an advantage over reformer-burners because the fuel cell is a more efficient fuel consumer than a reformer-burner. Thus, instead of consuming fuel in the reformer-burner at a relatively low efficiency, the fuel is consumed by the more efficient fuel cell. This implies the option of a higher efficiency of the overall system. Additionally, as becomes more apparent in the following, the waste heat from the fuel cell is reused for the heating of the reformer.

By using H2 separation and recycling, an efficiency gain of 7.5% is achieved. For an electrical heater, most of it is consumed again. However, when the HT-PEM fuel cells are driven at 170° C., the heat pump can lift the temperature to 250° C. at moderate energy consumption, and the net gain for the system is more than 5%. These estimates include the electrical consumption by the H2-separator. As the heat pump system is the most favourable for the HT-PEM system, this is explained in greater detail below.

In practical embodiments, the heat pump is thermally connected to the cooling circuit for extracting thermal energy from the coolant and lowering the temperature of the coolant, which is advantageous for the efficiency of the fuel cell system, as the heat is normally a waste product but which is useful in the herein described system. Thermal energy from the coolant downstream of the fuel cell is extracted from the coolant and transferred to a heating fluid in a heating circuit which is connected to the reformer for transferring thermal energy from the heating fluid to the reformer. Taking offset in the lower temperature in the cooling circuit, the temperature of the heating fluid in the heating circuit must be raised by the heat pump to a temperature that is necessary for the reformation and which is above the temperature of the coolant.

With reference to the above example of a HT-PEM operating at 170° C. and an example of a predetermined reformer temperature T_{ref}=250° C. for the reformation of methanol, the temperature of the heating fluid must be raised to a temperature not lower than 250° C., and possibly even slightly higher, to maintain the temperature in the reformer at 250° C.

Current heat pumps used in systems with LT-PEM fuel cells, operating below 100° C., are not expected to yield an efficiency increase for the system as compared to similar systems using reformer-burners. Accordingly heat pumps do not appear attractive for such systems. However, it cannot be excluded that future developments would make use of heat pumps in such LT-PEM fuel cell systems attractive from the perspective of increasing the energy efficiency. Irrespectively thereof, heat pumps may find way into such LT-PEM fuel cell systems due to other advantages, for example simplicity and profit considerations. It is therefore justified to extend the idea of using heat pumps for heating the reformer in HT-PEM fuel cell systems to systems with other types of fuel cells, for example LT-PEM fuel cell systems.

For example, the heat pump comprises a multi-stage gas piston compressor using a working medium for the heat pumping. Various working media exist, some of the efficient heat pumps using steam or helium as a working medium.

Examples of heat pumps that can lift the temperature are found in the commercial market. For example by the company Spilling TechnologiesR GmbH in Germany produces heat pumps using multi-stage steam compressors in modular design with up to 6 cylinders and being able to heat up to 280° C., with a useful Coefficient of Performance, COP, above 2. For lower temperatures than 250° C., the COP is higher, for example as high as 8 or above for a source temperature of 175° C. to an outgoing temperature of 215° C. For a higher outgoing temperature, such as 250° C., the COP is lower but can be expected to be at 5.

With the current state-of-the-art heat pump technology, it is possible to use heat pumps that can perform the lift of the temperature from T2=170° C. to T_{ref}=250° C., making them useful for methanol reformation and HT-PEM cells, in particular. As mentioned above already, for such HT-PEM systems, where the reformer is heated by using a heat pump, and the H2 gas from the anode is recycled, a total efficiency increase of more than 5% has been found as compared to the current state of the art fuel cell systems in which the reformer is heated by a fuel-burner as reformer-heater. This high beneficial increase of the efficiency is made possible, in particular, because the fuel cell is operating at a relatively high temperature that is below but relatively close to the temperature T_{ref} for the reformation. In these calculations, a COP=5 has been assumed. For a simple scaling, it was found that a COP=4 results in an efficiency gain of 4%, a COP=3 results in an efficiency gain of 3%, and a COP-2 results in an efficiency gain of 2%. Thus, even at lower COP than the expected COP-5, for example a COP in the range of 2 to 4, provides a gain when using a heat pump as compared to when using a burner and when the H2 is recycled to the anode.

Particularly interesting is the use for larger fuel cell systems, such as designed for marine vessels. Also, particular interest have fuel cell systems for stationary power stations with electricity production capacities of at least 1 MW.

Multistage compressor heat pumps of large size can be used so that the efficiency gain relatively quickly balances depreciation of the additional investment. For example, the above-mentioned company Spilling Technologies® GmbH provides heat pumps with capacities in the range of 1 MW to 15 MW, having a weight of 15,000-45,000 kg. Needless to state that such heat pumps require large installations, such as marine vessels, especially container cargo ships, or power plants, or large-scale energy storage system, for example discussed in connection with the so-called Power-to-X (PtX) options for converting and storing green energy.

Another possible candidate for heat pumps is among the machines provided by EnerinR Energy Engineering, where the heat pump uses a Stirling cycle with a closed single phase system undergoing compression and expansion by double-acting pistons, with an expected COP of 2.5. The heat pump can lift temperatures by 200 degrees, however, limited to a minimum source temperature of 100° C., which makes it suitable for HT-PEM but not for LT-PEM. The heat supply capacity is in the range of 0.3 MW to 10 MW, having a weight of 10,000 kg.

In the fuel cell system presented herein, a flow of coolant through the fuel cell is provided with the coolant entering the fuel cell being at a first temperature T1, for example 160° C., and leaving the fuel cell at a second increased temperature T2, for example 170° C., which is higher than the first temperature T1. In order to maintain stable and optimum operation temperature of the fuel cell, the heat pump, which receives the coolant downstream of the fuel cell should not lower the temperature of the coolant at the downstream end of the heat pump system to a third temperature T3 below the first temperature T1. This can be achieved by proper adjustment of the flow and design of the heat pump, for example by selecting heat pumps with proper specs, as discussed above.

For the example of the fuel cell system comprising a reformer for reformation of alcohol, such as methanol, the methanol is mixed with water and supplied as evaporated steam to the reformer. The heat for the evaporation is advantageously taken from the coolant in the coolant circuit. For example, the necessary thermal energy can be taken at the low-temperature branch of the cooling circuit, where the temperature is closer to the coolant temperature T1 that is fed into the fuel cell, for example T1=160° C., or the necessary thermal energy can be taken at the high temperature branch in the cooling circuit with the coolant temperature T2 at the exit of the fuel cell, for example T2=170° C. Having in mind that the heat pump has to lift the temperature to the reformation temperature T_{ref}, for example 250° C., it is better to feed the heat pump with the coolant having the highest available temperature. The consequence is that the evaporator has to be connected in the low temperature branch of the cooling circuit, downstream of the location where the heat pump system takes thermal energy from the cooling circuit.

However, in this case, as the evaporator takes up heat from the coolant, the coolant coming from the heat pump having a temperature T3 at the inlet of the evaporator should have a temperature T3 slightly higher, for example 2-4 degrees higher, than the coolant temperature T1 that is used at the cooling inlet of the fuel cell. Accordingly, when using an evaporator, the heat pump should lower the temperature of the coolant, for example from the level T2, to a temperature T3 that is higher than T1, at which the coolant is fed into the fuel cell.

Optionally, a further heat exchanger is used between the evaporator and the fuel cell for fine-adjustment of the temperature of the coolant before entering the fuel cell.

### SHORT DESCRIPTION OF THE DRAWINGS

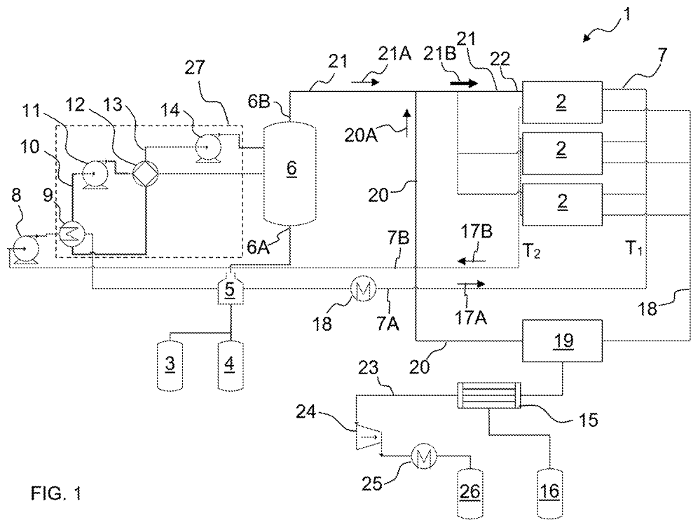

The invention will be explained in more detail with reference to the drawing, where FIG. 1 is an overview sketch of the fuel cell system.

### DETAILED DESCRIPTION/PREFERRED EMBODIMENT

FIG. 1 illustrates a fuel cell system 1 comprising a plurality of fuel cells 2, typically arranged in parallel as a fuel cell stack, as illustrated. Methanol as fuel from a fuel tank 3 in combination with water from a water tank 4 are mixed and evaporated in an evaporator 5. The evaporated mix of methanol and water is fed into an inlet 6A of a catalytic reformer 6, which produces syngas as reformate. Such syngas contains carbon dioxide, CO2, carbon monoxide, CO, and hydrogen gas, H2, as well as some remains of water. The syngas is fed from the reformate outlet 6B, as indicated by arrow 21A, into an inlet 22 of the anode of the fuel cell 2, and H2 is used for production of electricity by the fuel cell 2.

In the exemplified case, the fuel cell 2 is a HT-PEM fuel cell, which is not sensitive to CO and which does not need a shift reactor and neither a high water steam content in the syngas, in contrast to LT-PEM cells.

As alternative to methanol, other alcohols can be used, for which the reformer temperature would have to be correspondingly adjusted.

The HT-PEM fuel cells 2 are by example driven at a temperature in the range of 170° C.-180° C., so that the coolant in the cooling circuit 7, pumped towards to the fuel cell stack by coolant pump 8 in directions indicated by arrows 17A and 17B, is heated from T1=160° C. to T2=170° C. It is possible to drive the fuel HT-PEM cells 2 at slightly different temperature in the range of 120° C.-200° C., but typically in the range of 150° C.-180° C. Advantageously, the polymer electrolyte membrane PEM in the HT-PEM fuel cell is mineral acid based, typically a polymer film, for example polybenzimidazole (PBI) doped with phosphoric acid.

The reformer 6 is heated by reformer-heater 27, indicated by a stippled line in FIG. 1, the components of which are explained in more detail in the following.

The coolant flowing from the fuel cells 2, as indicate by arrow 17B, at a temperature of T2 from the fuel cells 2 is transferring thermal energy in transfer heat exchanger 9 to a transfer fluid in a transfer circuit 10, in which the transfer fluid is pumped by a transfer pump 11.

The transfer circuit 10 is in thermal connection with an electrically driven heat pump 12. The heat pump 12 transfers thermal energy from the transfer fluid in the transfer circuit 10 to a heating fluid that is circulating in a heating circuit 13, driven by a corresponding heating fluid pump 14, which heats the reformer 6.

An advantage of the transfer circuit 10 is easy adjustment of the entrance temperature into the heat pump 12 and adjustment of the temperature of the coolant in the cooling circuit 7 downstream of the transfer heat exchanger 9.

In the illustrated system, the coolant in the low temperature branch 7A of the cooling circuit 7, downstream of the transfer heat exchanger 9, is used to heat the mix of fuel and water in the evaporator 5, after which the temperature of the coolant should be T1, for example T1=160° C. for maintaining a stable operation temperature of the fuel cells 2. Fine adjustment of the temperature to T1 can be done with an adjustment heat exchanger 18. Depending on the need of heat in the evaporator 5, which varies with load and corresponding fuel consumption by the fuel cells 2, the temperature of the coolant in the cooling circuit 7 can be adjusted by regulating the transfer of thermal energy in the transfer heat exchanger 9 upstream of the evaporator 5. The electricity consumption of the heat pump 12 is adjusted in dependence on the temperature of the transfer fluid in the transfer circuit 10 and the need for heat in the reformer 2.

An example of a heat pump for raising the temperature of the transfer fluid from a temperature in the range of 120° C.-200° C. to a temperature of the heating fluid of at least T_{ref}=220° C., optionally raising the temperature of the transfer fluid from a temperature in the range of 150° C.-180° C. to the temperature of the heating fluid of at least T_{ref}=250° C.

By using a reformer heater 27 as presented herein, which includes the heat exchanger 9, transfer circuit 10 with its pump 11, and the heating circuit 13 with its pump 14, as well as the heat pump 12, no fuel or H2 gas is needed for a reformer-burner, so that the H2 gas that is leftover in the anode exhaust gas conduit 18 can be separated by the H2-separator 19, which is, for example an electrochemical H2-separator, and fed through H2-conduit 20 into a syngas-conduit 21 that connect the reformate outlet 6B of the reformer 6 with the inlet 22 of the anode of the fuel cell 2. The flow of H2 gas in the H2-conduit 20, as indicated by arrow 20A, downstream of the separator 19 is added to the syngas that is flowing from the reformer (6) in the syngas-conduit 21, as indicated by arrow 21A, and results in a combined flow, as indicated by thickened arrow 21B in syngas-conduit 21 upstream of the anode inlet 22 of the fuel cell 2.

Additionally, as the H2 gas has been separated from the anode exhaust gas in exhaust conduit 18 by the H2-separator 19, the remaining gases, primarily water steam and CO2 gas can, in principle, be discarded. Optionally, however, the water is separated from the CO2 gas in condenser 15 and collected in water reservoir 16, potentially for being reused for mixing with fuel. The remaining CO2 in the CO2-conduit 23 is, optionally, collected as liquid in CO2-tank 26, for example after compression in compressor 24 and condensation in heat exchanger 25.

Notice that the additional elements of H2-separation and H2 recycling into the fuel cell and not into a burner, as well as water recycling and potential carbon capture all benefit from the use of the heat-pump 12 so that the overall result of the addition of these elements is not a mere aggregation but a synergistic combination of elements leading to an overall improved and environmentally friendly system.

1. A fuel cell system comprising
a fuel supply for supplying fuel,
a reformer for catalytic reformation of the fuel into syngas containing hydrogen, H2,
a fuel cell having an anode with an anode inlet that is flow-connected to a reformate-outlet (6B) of the reformer for receiving the H2 and using the H2 for producing electricity,
a reformer-heater for heating the reformer to a predetermined reformer temperature T_{ref} that is not lower than a minimum temperature necessary for the catalytic reformation of the fuel,
a cooling circuit containing a flow of coolant for maintaining an operation temperature of the fuel cell,
the system further comprises an H2-separator connected to an anode-exhaust conduit downstream of the anode for receiving the anode exhaust gas and for separating H2 from the anode exhaust gas, wherein the H2-separator is flow-connected to a syngas-conduit that connects the reformate-outlet (6B) to the inlet of the anode for recycling the separated H2 gas into the anode after mixing with the syngas from the reformer,
wherein the fuel comprises alcohol and the fuel cell is a HT-PEM fuel cell, the operation temperature of which is in the range of 120° C.-200° C. and less than the predetermined reformer temperature T_{ref} and that the reformer-heater is an electrically driven reformer-heater.

2. The system according to claim 1, wherein the H2-separator is an electrochemical H2-separator.

3. The system according to claim 1, wherein the system downstream of the H2-separator comprises a water separator for separating water from the anode exhaust gas after H2-sparation and a CO2 liquefier and further a CO2 storage tank for storing the remaining CO2 in liquid form.

4. The system according to claim 1, wherein the electrically driven reformer heater comprises an electrically driven heat pump that is thermally connected to the cooling circuit for extracting thermal energy from the coolant and lowering the temperature of the coolant and transferring the extracted thermal energy to a heating fluid in a heating circuit for heating the heating fluid and for providing the heating fluid at a temperature not lower than the predetermined reformer temperature T_{ref}, wherein the heating circuit is connected to the reformer for transferring thermal energy from the heating fluid to the reformer.

5. The system according to claim 4, wherein the fuel comprises methanol and water, and wherein the system comprises an evaporator for receiving and evaporating the fuel for reformation in the reformer, wherein the cooling circuit is configured for maintaining an operation temperature of the HT-PEM fuel cell-in the range of 150° C.-180° C., wherein the predetermined reformer temperature T_{ref} is in the range of 250° C.-300° C.

6. The system according to claim 4, wherein the heat pump comprises an electrically driven multi-stage gas piston compressor and wherein the COP for heating the reformer to the predetermined reformer temperature T_{ref} by the heat pump is not less than 2.

7. A method for operating a fuel cell system, wherein the method comprises
heating a catalytic reformer by a reformer-heater to a predetermined reformer temperature T_{ref} not lower than a minimum temperature necessary for catalytic reformation of fuel into syngas containing hydrogen, H2,
maintaining an operation temperature of a fuel cell by a cooling circuit containing a flow of coolant;
reforming fuel by the reformer into syngas containing hydrogen, H2, and feeding the syngas into an anode of the fuel cell and producing electricity by the fuel cell by consuming a first portion of the H2, and releasing a second portion of the H2 from the anode as part of an anode exhaust gas;
receiving the anode exhaust gas by an H2-separator and separating H2 from the anode exhaust gas and recycling the separated H2 into the anode;
wherein the fuel comprises alcohol and the system comprises a fuel evaporator, and that the fuel cell is a HT-PEM fuel cell and that the reformer-heater is an electrically driven reformer-heater, and that the method comprises receiving and evaporating the fuel in the evaporator and feeding the evaporated fuel into the reformer, operating the fuel cell at an operation temperature in the range of 120° C.-200° C., and by the reformer heater maintaining a predetermined reformer temperature T_{ref} that is not lower than a minimum temperature necessary for the catalytic reformation of the fuel.

8. The method according to claim 7, wherein the method comprises adding the separated H2 gas to the syngas from the reformer in a syngas-conduit that connects a reformate-outlet of the reformer with a gas inlet of the anode of the fuel cell.

9. The method according to claim 7, wherein the H2-separator is an electrochemical H2-separator.

10. The method according to claim 7, wherein the method comprises separating H2O from the anode exhaust gas after H2-sparation and capturing carbon by liquefying remaining CO2 and storing the CO2 as liquid in a storage tank.

11. The method according to claim 7, wherein the reformer heater comprises an electrically driven heat pump that is thermally connected to the cooling circuit, and wherein the method comprises driving the heat pump by electricity and extracting thermal energy from the coolant in the cooling circuit and lowering the temperature of the coolant by the heat pump and transferring the extracted thermal energy to a heating fluid in a heating circuit and heating the heating fluid and providing the heating fluid at a temperature not lower than the predetermined reformer temperature T_{ref} and transferring thermal energy from the heating fluid to the reformer.

12. The method according to claim 11, wherein the method comprises maintaining an operation temperature of the fuel cell in the range of 150° C.-180° C. by the cooling circuit and heating the reformer by using the heat pump to a temperature in the range of 250° C.-300° C.

13. The method according to claim 11, wherein the method comprises providing a flow of coolant through the fuel cell, the coolant entering the fuel cell at a first temperature T1 and leaving the fuel cell at a second increased temperature T2 that is higher than the first temperature T1, for example T1=160° C. and T2=170° C., and wherein the heat pump receives the coolant after temperature increase to T2 by the fuel cell, and wherein the method comprises extracting thermal energy from the coolant by using the heat pump and lowering the temperature of the coolant to a third temperature T3 that is lower than T2 but not lower than the first temperature T1.

14. The method according to claim 13, wherein the method comprises lowering the temperature of the coolant by the heat pump to a third temperature T3 that is lower than T2 but higher than the first temperature T1, and feeding the coolant downstream of the reformer heater-into an evaporator and transferring thermal energy from the coolant to the fuel for evaporation of the fuel in the evaporator prior to the fuel entering the reformer and lowering the temperature from the third temperature T3 to a fourth temperature T4 by this transfer of thermal energy in the evaporator, wherein the fourth temperature T4 is not lower than the first temperature T1.

15. Use of a system according to claim 1 for producing electricity on an electrically driven marine vessel.

16. Use of a method according to claim 7 for producing electricity on an electrically driven marine vessel.
